(19) United States
(12) Patent Application Publication
(10) Pub. No.: US 2004/0137865 A1
(43) Pub. Date: Jul. 15, 2004

(54) Method and integrated circuit for tuning an LC resonator and electrical apparatus comprising an LC resonator

(76) Inventors: Francois Callias, Fontaines (CH); Reto Philp, Lausanne (CH); Rainer Platz, Neuchatel (CH)

Correspondence Address: PEARNE & GORDON LLP, 1801 EAST 9TH STREET, SUITE 1200, CLEVELAND, OH, 44114-3108, US

(21) Appl. No.: 10/339,528

(22) Filed: Jan. 9, 2003

(51) Int. Cl. H04B 1/18

(52) U.S. Cl. 455/179.1; 455/180.4; 455/180.2; 455/188.1

(57) ABSTRACT

For tuning an LC resonator (2) which particularly comprises a miniaturized antenna coil (L_{A}), a variable capacitance (C_{T}) is connected in parallel to the LC resonator (2). At manufacturing time, a maximum resonance frequency of the LC resonator (2) is measured when the variable capacitance (C_{T}) is set to its minimum value, a minimum resonance frequency of the LC resonator (2) is measured when the variable capacitance (C_{T}) is set to its maximum value, and coded values of the measured maximum and minimum resonance frequencies are stored in non-volatile memories (Fₘᵢₙ, Fₘₐₓ). At operations time, a binary tuning code (B) is computed as a linear interpolation between the stored values of the minimum and maximum resonance frequencies for a target resonance frequency (fₜ). The LC resonator (2) is tuned to the target resonance frequency (fₜ) by selectively connecting separate binary weighted capacitors (Cₙ₋₁, . . . , C₂, C₁, C₀) of the variable capacitance (CT) in parallel to the LC resonator (2) in accordance with the value of the computed binary tuning code (B).

### BACKGROUND OF THE INVENTION

The present invention relates to a method and an integrated circuit for tuning an LC resonator and to an electrical apparatus comprising an LC resonator. Specifically, the present invention relates to a method and an integrated circuit for tuning an LC resonator and to an electrical apparatus comprising an LC resonator, which all use a variable capacitance for tuning the LC resonator.

Tuning of LC resonators is often required for LC resonators that are part of a load circuit of a pre-amplifier or an oscillator, for example. Particularly, LC resonators with antenna coils serving as antennas for radio receivers require tuning when the receivers cover a wider frequency range than the antennas.

Miniaturized antennas, respectively antenna coils, with geometrical dimensions that are small compared to the wavelength of received signals generally have a high quality factor Q. On the one hand, the sensitivity of a complete receiver system, comprising a radio receiver and an antenna connected to the receiver, is proportional to the quality factor Q of the antenna. On the other hand, the 3 dB bandwidth of an antenna is inversely proportional to the quality factor Q of the antenna, For example, an antenna with a quality factor of Q=100, has a 3 dB bandwidth of only ˜2 MHz at a frequency of 200 MHz. Therefore, the 9 dB bandwidth of a miniaturized antenna is generally much smaller than the tuning range of the receiver.

Consequently, in order to cover the entire frequency range of the receiver with one single antenna, the antenna needs to be tuned when the signal frequency is changed. Typically, antennas are tuned by means of a variable capacitance connected in parallel to the antenna.

In formula (1) the resonance frequency fᵣₑₛ an LC resonator comprising an antenna coil L_{A} and a parallel tuning capacitance C_{A} is defined:

fᵣₑₛ=1/2π\sqrt{L_{A}C_{A}} (1)

As indicated in formula (2), the resonance frequency fᵣₑₛ of the LC resonator can be modified by adding an additional tuning capacitance C_{T} in parallel:

fᵣₑₛ=1/2π\sqrt{L_{A}(C_{A}+C_{T})} (2)

In the patent U.S. Pat. No. 4,862,516 a system for automatically tuning the antenna of a miniature portable communications device is described. According to U.S. Pat. No. 4,862,516 the antenna is tuned by varying the capacitance of a varactor diodes connected in parallel to the antenna. The system according to U.S. Pat. No. 4,862,516 is based on the transmission of a tuning mode signal combined with active control of the tuning means for obtaining a maximum signal. The magnitude of the received signal is measured, a tuning control signal is generated and supplied to a D/A converter to effect tuning of the antenna by monitoring the variations in the magnitude of the received signal. The transmission of a tuning mode signal according to U.S. Pat. No. 4,862,516 requires a special transmitter. Generally, the transmission of a tuning signal limits the cross-compatibility between different transmitter-receiver systems as the accurate calibration of the receiver tuning circuit has to be known by the transmitter. In principle, each transmitter-receiver pair would need to be calibrated together Moreover, owing to the dependency on receiving the special tuning mode signal, it is not possible to have the system automatically and autonomously scan a frequency range and tune the antenna. Finally, active tuning control with a feedback path requires a relatively complex system.

A similar method for active tuning control with feedback is described in the patent U.S. Pat. No. 5,438,688. According to U.S. Pat. No. 5,438,688 the signal strength of the received signal is measured and from the measured signal strength an antenna tuning voltage is derived for controlling the tuning means. According to U.S. Pat. No. 5,438,688 a predictor value for coarse tuning is obtained from previous tuning cycles.

In the patent U.S. Pat. No. 5,589,844 another active tuning control system is described wherein the capacitance of capacitive elements is adjusted electromechanically. According to U.S. Pat. No. 5,589,844 initial impedance values are determined for each frequency in an operating range and stored in a non-volatile memory.

In the patent U.S. Pat. No. 5,491,715 another method for actively tuning an antenna based on a feedback signal is described wherein the antenna is tuned to a desired frequency by modifying the value of capacitors connected in parallel to the antenna.

All antenna tuning systems based on active control with a feedback path have the disadvantage of requiring relatively complex active controlling means. When integrating the antenna tuning system on a chip, the complex analog circuitry used for the active controlling means increases both the size of the silicon surface and the power consumption of the chip. Furthermore, whenever the frequency is changed, tuning systems based on active control require time for tuning optimization which is particularly unfavorable, i.e. time-consuming, when a channel scan is performed. Moreover, if no carrier is present on a channel, the scan could end in an infinite loop, the receiver trying to optimize on a non-existing signal. Similarly, if there is no signal available before tuning, because the antenna is untuned, tuning the antenna by means of an active control mechanism is difficult as the signal to optimize is not available and needs first “to be found.”

### SUMMARY OF THE INVENTION

It is an object of this invention to provide a method, an integrated circuit and an electrical apparatus which are capable of tuning an LC resonator and which do not have the disadvantages of the prior art. In particular, it is an object of the present invention to provide a method, an integrated circuit and an electrical apparatus capable of automatically tuning a miniaturized antenna over a large frequency band without using active control mechanisms with feedback.

According to the present invention, these objects are achieved particularly through the features of the independent claims. In addition, further advantageous embodiments follow from the dependent claims and the description.

A variable capacitance for tuning the LC resonator is connected in parallel to the LC resonator. In the preferred application, the inductance of the LC resonator comprises an antenna coil, particularly a miniaturized antenna coil.

According to the present invention, the above-mentioned objects are particularly achieved in that at manufacturing time, a maximum resonance frequency of the LC resonator is measured when the variable capacitance connected in parallel to the LC resonator is set to its minimum value and a coded value of the measured maximum resonance frequency is stored in a first memory of a tuning module, and a minimum resonance frequency of the LC resonator is measured when the variable capacitance is set to its maximum value and a coded value of the measured minimum resonance frequency is stored in a second memory of the tuning module. The first and second memories of the tuning module are preferably non-volatile memories. At operations time, a tuning code for setting the variable capacitance to a value that results in a target resonance frequency of the LC resonator is computed as an interpolation between the coded value stored in the first memory and the coded value stored in the second memory for a coded value of the target resonance frequency, and the value of the variable capacitance is adjusted in accordance with the value of the computed tuning code. Advantageously, the LC resonator and correspondingly a miniaturized antenna can be tuned without using active control mechanisms with feedback; there is no need for measuring signal strength and no special tuning mode signal is necessary. The LC resonator and correspondingly the miniaturized antenna can be tuned in the time it takes to perform one single computation. Finally, owing to their reduced complexity, the module for tuning the LC resonator and correspondingly for tuning the miniaturized antenna can be fully integrated on a chip, for example through a CMOS process.

In a preferred embodiment, the variable capacitance connected in parallel to the LC resonator comprises several separate capacitors, and the value of the variable capacitance is adjusted by selectively closing switches associated with each of the separate capacitors in accordance with the value of the determined tuning code. Preferably, the switches are implemented as transistors, and the computing means, the transistors and the separate capacitors are integrated on a chip, for example a CMOS chip. Latest CMOS technologies make it possible to build MOS transistor switches with sufficiently low on-resistance at low supply voltages. Furthermore, these MOS transistors have small parasitic capacitances which makes them appropriate for applications in the VHF and UHF frequency range.

In the preferred embodiment the tuning code is a binary code, the values of the separate capacitors are binary weighted, and the bits composing the tuning code are assigned to the switches associated with the separate capacitors such that the binary weight of each bit corresponds to the binary weight of the separate capacitor associated with the switch. Using a binary tuning code and binary weighted values of the separate capacitors makes possible an extremely simple interconnection of the computing means and the variable capacitance, thereby reducing size and power consumption of the tuning module or its corresponding integrated circuit, respectively.

Preferably, the tuning code is computed as a linear interpolation, comprising computing a ratio of the difference between the coded value stored in the first memory and the coded value of the target resonance frequency and of the difference between the coded value stored in the first memory and the coded value stored in the second memory. Computing the tuning code as a linear interpolation makes it possible to use computing means of very simple complexity, thereby reducing size and power consumption of the tuning module or its corresponding integrated circuit, respectively.

Preferably, the LC resonator comprises a trim capacitor for a one-time simple and straightforward calibration of the LC resonator at manufacturing time. The LC resonator can be calibrated to a desired maximum resonance frequency by disconnecting all the separate capacitors of the variable capacitance and by setting the trim capacitor to the appropriate calibration value. The one-time calibration with local calibration means makes transmission of special tuning signals unnecessary.

### BRIEF DESCRIPTION OF THE DRAWINGS

The present invention will be explained in more detail, by way of example, with reference to the drawings in which:

FIG. 1 shows a block diagram illustrating an electrical apparatus with an LC resonator connected to a module for tuning the LC resonator, which module comprises a variable capacitance controlled by computing means.

FIG. 2 shows a block diagram illustrating an LC resonator connected to a circuit for tuning the LC resonator, which circuit comprises several separate capacitors selectively connectable in parallel to the LC resonator.

### DETAILED DESCRIPTION OF THE PREFERRED EMBODIMENTS

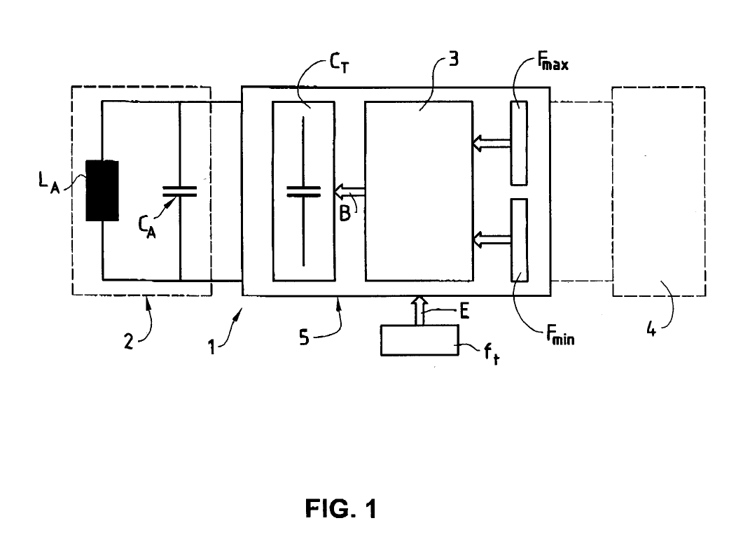

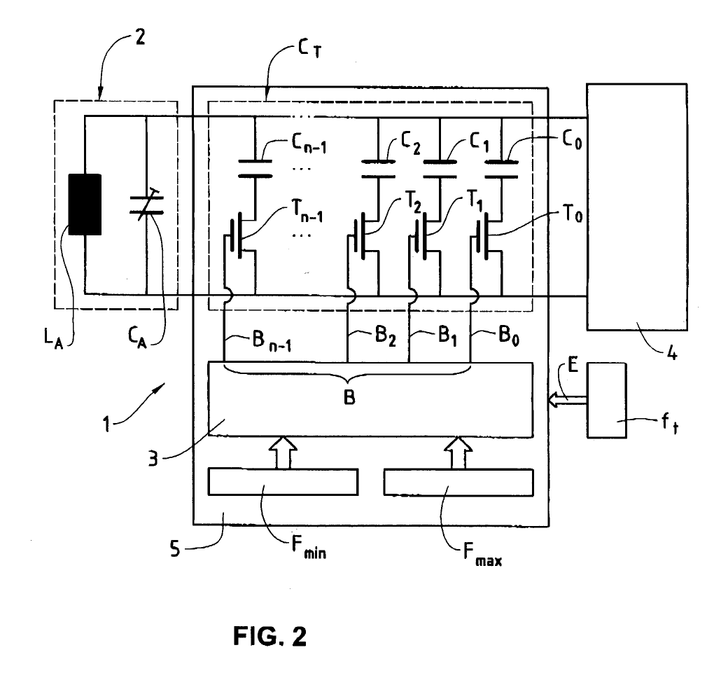

In the FIGS. 1 and 2, the reference numeral 1 refers to an electrical apparatus comprising an LC resonator 2, a tuning module 5 and an optional radio receiver 4, connected to the LC resonator 2. As is illustrated in FIGS. 1 and 2, the LC resonator 2 comprises an inductance LA and a capacitance CA In a preferred application, the inductance LA is an antenna coil, particularly a miniaturized antenna coil, connected to the radio receiver 4. The geometrical dimensions of a miniaturized antenna coil are small compared to the wavelength of received radio signals. The miniaturized antenna coil of the inductance L_{A} is dimensioned for use in preferred applications in the VHF (Very High Frequency, 30-300 MHz) or UHF (Ultra High Frequency, 300 MHz-3 GHz) frequency range. Examples of miniaturized antennas used in preferred applications in the VHF frequency range are air coils with a diameter of approximately 4 mm and with typically 2 to 5 windings or coils wound on ferrite rods with approximate dimensions of (7×3×2) mm³. Preferably, the capacitance CA comprises a trim capacitor, as is illustrated in FIG. 2, for calibrating the LC resonator 2 according to formula (1) to the desired maximum resonance frequency at manufacturing time of the electrical apparatus 1.

As is illustrated in FIGS. 1 and 2, the tuning module 5 comprises a variable capacitance CT for tuning the LC resonator 2 which is connected in parallel to the LC resonator 2. Furthermore the tuning module 5 comprises memories Fₘₐₓ and Fₘᵢₙ for storing a coded value of a maximum resonance frequency and a coded value of a minimum resonance frequency, respectively, and computing means 3. The memories Fₘₐₓ and Fₘᵢₙ are preferably non-volatile memories, for example, EPROM or EEPROM. The computing means 3 are preferably implemented as non-programmable logic circuits. Alternatively, the computing means can be implemented by means of programmable logic circuits or by means of a combination of a processor and program code. Finally, the tuning module 5 comprises an interface E for receiving a coded value of a target resonance frequency ft. The coded value of the target resonance frequency ft can be input by means of an operating element, such as a dial, or by means of a wireless receiver receiving the coded value of the target resonance frequency ft via electromagnetic waves from an external remote control. Alternatively, the interface E may also be part of a hard wired or programmable core command unit of the device 1. This core command unit may be provided with the input means mentioned above, e.g. with operating elements or wireless receivers, or else, the target resonance frequency ft may be generated within the core command unit. The values of the frequencies can be coded as binary frequency codes or as decimal values or according to another coding scheme.

As will be explained later in detail, the computing means 3 compute a tuning code B for adjusting the value of the tuning capacitance CT. As is illustrated in FIG. 1, the tuning code B output by the computing means 3 is passed to the tuning capacitance CT.

In a possible embodiment, the tuning capacitance CT comprises a capacitive varactor diode connected to a D/A-converter (Digital/Analog) receiving the tuning code B output by the computing means 3.

In the preferred embodiment illustrated in FIG. 2, the tuning capacitance CT comprises several separate capacitors Cₙ₋₁, . . . , C₂, C₁, C₀. Each one of the separate capacitors Cₙ₋₁, . . . , C₂, C₁, C₀ is connected in series to an associated switch Tₙ₋₁, . . . , T₂, T₁, T₀. The switches Tₙ₋₁, . . . , T₂, T₁, T₀ are preferably transistors. The separate capacitors Cₙ₋₁, . . . , C₂, C₁, C₀ can each be selectively connected in parallel to the LC resonator 2 by closing its associated switch Tₙ₋₁, . . . , T₂, T₁, T₀ or disconnected by opening its associated switch Tₙ₋₁, . . . , T₂, T₁, T₀, respectively. The control gates of the switches Tₙ₋₁, . . . , T₂, T₁, T₀ are connected to the outputs Bₙ₋₁, . . . , B₂, B₁, B₀ of the computing means 3, each output Bₙ₋₁, . . . , B₂, B₁, B₀ representing one bit of the tuning code B. A high value (ON: bit=“1”) on an output Bₙ₋₁, . . . , B₂, B₁, B₀ closes, and a low value (OFF: bit=“0”) on an output Bₙ₋₁, . . . , B₂, B₁, B₀ opens, the respective switch Tₙ₋₁, . . . , T₂, T₁, T₀. Preferably, the tuning code B is a binary code, and the values of the separate capacitors Cₙ₋₁, . . . , C₂, C₁, C₀ are binary weighted. The binary weight of each separate capacitor Cₙ₋₁, . . . , C₂, C₁, C₀ corresponds to the binary weight of the bit of the tuning code represented on the output Bₙ₋₁, . . . , B₂, B₁, B₀ that is controlling the switch Tₙ₋₁, . . . , T₂, T₁, T₀ connected to the respective separate capacitor Cₙ₋₁, . . . , C₂, C₁, C₀. Hence the total value of the capacitance of the separate capacitors Cₙ₋₁, . . . , C₂, C₁, C₀ connected in parallel to the LC resonator 2 corresponds to the value of the binary tuning code B output by the computing means 3.

The tuning module 5 is preferably implemented as an integrated circuit on a chip. Preferably, the separate capacitors Cₙ₋₁, . . . , C₂, C₁, C₀, the switches Tₙ₋₁, . . . , T₂, T₁, T₀, the computing means 3 and the memories Fₘₐₓ and Fₘᵢₙ are manufactured in CMOS (Complementary Metal-Oxide-Semiconductor) technology. The tuning module 5 and the radio receiver 4 can be implemented on one common chip or on separate chips.

At manufacturing time of the electrical apparatus 1, the variable capacitance C_{T} is set to its minimum value, i.e, in the preferred embodiment, all the separate capacitors Cₙ₋₁, . . . , C₂, C₁, C₀ are disconnected by opening all the switches Tₙ₋₁, . . . , T₂, T₁, T₀ (i.e. tuning code B=‘0 . . . 000’) Then the LC resonator 2 is calibrated to a desired maximum resonance frequency by adjusting the value of the capacitance C_{A}. The calibrated maximum resonance frequency of the LC resonator 2 is measured by means of an external measuring device and stored as a coded value in the memory Fₘₐₓ of the tuning module 5. From the external measuring device, the coded value of the maximum resonance frequency can be stored in the memory Fₘₐₓ via the interface E, for example.

Thereafter, the variable capacitance C_{T} is set to its maximum value, i.e. in the preferred embodiment, all the separate capacitors Cₙ₋₁, . . . , C₂, C₁, C₀ are connected in parallel to the LC resonator by closing all the switches Tₙ₋₁, . . . , T₂, T₁, T₀ (i.e. tuning code B=‘1 . . . 111’). At this setting, the minimum resonance frequency of the LC resonator 2 is measured and stored as a coded value in the memory Fₘᵢₙ of the tuning module 5. From the external measuring device, the coded value of the minimum resonance frequency can be stored in the memory Fₘᵢₙ via the interface E, for example.

During operation of the electrical apparatus 1, a target resonance frequency fₜ is input through the interface E to the computing means 3. The computing means 3 retrieve the coded value of the maximum resonance frequency stored in the memory Fₘₐₓ and the coded value of the minimum resonance frequency stored in the memory Fₘᵢₙ, and compute a tuning code B as an interpolation between the coded value of the maximum resonance frequency and the coded value of the minimum resonance frequency for the received coded value of the target resonance frequency fₜ.

In its simplest form the computation can be a linear interpolation according to formula (3), fₘₐₓ and fₘᵢₙ representing the values stored in the memories Fₘₐₓ and Fₘᵢₙ:

$$B = \frac{{f}_{max} - {f}_{t}}{{f}_{max} - {f}_{min}} \qquad ( 3 )$$

In the embodiment where the capacitance CT comprises several separate capacitors Cₙ₋₁, . . . , C₂, C₁, C₀, the value of the variable capacitance C_{T} corresponds to the sum of all the separate capacitors Cₙ₋₁, . . . , C₂, C₁, C₀ connected in parallel to the LC resonator 2, as defined in formula (4), wherein B[i] corresponds to the bits of the tuning code B on the outputs Bₙ₋₁, . . . , B₂, B₁, B₀:

$${C}_{T} = {\sum }_{i = 0}^{n - 1} {C}_{i} \cdot B [ i ] . \qquad ( 4 )$$

In the case of binary coding of the frequency values fₘₐₓ, fₘᵢₙ and fₜ, the tuning code B, having the most significant bit B[n−1] and the least significant bit B[0], is determined according to formula (5), wherein BIN[x] is the binary expression of x:

$$B [ n - 1 \text{:} 0 ] = BIN [ \frac{{f}_{max} - {f}_{t}}{{f}_{max} - {f}_{min}} \cdot ( {2}^{n} - 1 ) ] \qquad ( 5 )$$

The tuning code B[n−1:0] computed by the computing means 3 is assigned to the outputs Bₙ₋₁, . . . , B₂, B₁, B₀, the switches Tₙ₋₁, . . . , T₂, T₁, T₀ controlled by an Output Bₙ₋₁, . . . , B₂, B₁, B₀ carrying a bit with a high value get closed, and the associated separate capacitors Cₙ₋₁, . . . , C₂, C₁, C₀ are connected in parallel to the LC resonator 2.

Consequently, the value of the tuning capacitance C_{T} is adjusted according to the computed tuning code B, and the resonance frequency of the LC resonator 2 is tuned to the target resonance frequency ft according to formula (2). The LC resonator 2 can be tuned to any intermediate resonance frequency in the range from fₘᵢₙ to fₘₐₓ by connecting the separate capacitors Cₙ₋₁, . . . , C₁, C₀ in parallel to the LC resonator 2 according to the bits B[n−1:0] of the tuning code B.

The resulting total capacitance Cₜₒₜₐₗ comprising the capacitance C_{A} and the variable capacitance C_{T} is defined in formula (6):

$${C}_{total} = {C}_{A} + {C}_{0} \cdot {\sum }_{i = 0}^{n - 1} {2}^{i} \cdot B [ i ] \qquad ( 6 )$$

The resulting resonance frequency fᵣₑₛ of the LC resonator is given in formula (7):

fᵣₑₛ=1/2π\sqrt{L_{A}Cₜₒₜₐₗ} (7)

Because of the linearization of the function according to formula (1) in a limited frequency range, only a small error results. For example, using ten bits for the frequency coding and using five separate capacitors (n=5) for tuning an LC resonator 2 with an antenna coil will result in an attenuation of the antenna smaller than one decibel (<1 dB), which is more or less negligible.

What is claimed is:

1. A method for tuning an LC resonator comprising connecting a variable capacitance in parallel to the LC resonator, the method further comprising the steps of:
measuring a maximum resonance frequency of the LC resonator, the variable capacitance being set to its minimum value, and storing a coded value of the maximum resonance frequency in a first memory,
measuring a minimum resonance frequency of the LC resonator, the variable capacitance being set to its maximum value, and storing a coded value of the minimum resonance frequency in a second memory,
determining a tuning code for setting the variable capacitance to a value that results in a target resonance frequency of the LC resonator by.
reading the coded value of the maximum resonance frequency from the first memory,
reading the coded value of the minimum resonance frequency from the second memory, and
computing the tuning code as an interpolation between the coded value read from the first memory and the coded value read from the second memory for a coded value of the target frequency, and
adjusting the value of the variable capacitance in accordance with the value of the determined tuning code.

2. The method according to claim 1, wherein adjusting the value of the variable capacitance in accordance with the value of the determined tuning code is done by connecting selected separate capacitors of the variable capacitance in parallel to the LC resonator by closing switches associated with each of the selected separate capacitors in accordance with the value of the determined tuning code.

3. The method according to claim 2, wherein a binary code is used for the tuning code, in that the values of the separate capacitors are binary weighted, and in that bits composing the tuning-code are assigned to the switches associated with the separate capacitors such that the binary weight of each bit corresponds to the binary weight of the separate capacitor associated with the switch.

4. The method according to claim 1, wherein the tuning code is computed as a linear interpolation, comprising computing a ratio of the difference between the coded value read from the first memory and the coded value of the target frequency and of the difference between the coded value read from the first memory and the coded value read from the second memory.

5. The method according to claim 2, wherein it further comprises prior to measuring the maximum resonance frequency of the LC resonator, disconnecting all the separate capacitors of the variable capacitance and setting a trim capacitor of the LC resonator to a calibration value that results in a desired maximum resonance frequency of the LC resonator, and prior to measuring the minimum resonance frequency of the LC resonator, connecting all the separate capacitors of the variable capacitance in parallel to the LC resonator.

6. The method according to claim 1, wherein it comprises measuring the maximum resonance frequency and the minimum resonance frequency at manufacturing time of an electrical apparatus comprising the LC resonator and storing the coded values of the measured maximum resonance frequency and of the measured minimum resonance frequency in non-volatile memories.

7. The method according to claim 1, wherein an antenna coil, particularly a miniaturized antenna coil, is used as an inductance of the LC resonator.

8. The method according to claim 2, wherein transistors are used for the switches, and in that the computing means, the transistors and the separate capacitors of the variable capacitance are integrated on a chip.

9. The method according to claim 8, wherein the separate capacitors of the variable capacitance are integrated on a CMOS chip, and in that MOS transistors are used for the switches.

10. The method according to claim 1, wherein an LC resonator having a resonance frequency in the VHF or UHF frequency range is used.

11. An electrical apparatus comprising an LC resonator and a variable capacitance connected in parallel to the LC resonator,
wherein the electrical apparatus comprises a first memory, having stored therein a coded value of a maximum resonance frequency of the LC resonator measured for the variable capacitance set to its minimum value,
wherein the electrical apparatus comprises a second memory, having stored therein a coded value of a minimum resonance frequency of the LC resonator measured for the variable capacitance set to its maximum value,
wherein the electrical apparatus comprises computing means for computing a tuning code for setting the variable capacitance to a value that results in a target resonance frequency of the LC resonator, the computing means being connected to the first memory and to the second memory, and the tuning code being computed as an interpolation between the coded value stored in the first memory and the coded value stored in the second memory for a coded value of the target frequency, and
wherein the electrical apparatus comprises means for adjusting the value of the variable capacitance in accordance with the value of the determined tuning code.

12. The electrical apparatus according to claim 11, wherein the variable capacitance comprises several separate capacitors and switches associated with each of the separate capacitors for selectively connecting the separate capacitors in parallel to the inductance, and in that the electrical apparatus comprises means for connecting selected ones of the separate capacitors in parallel to the LC resonator by closing the switches associated with the selected separate capacitors in accordance with the value of the determined tuning code.

13. The electrical apparatus according to claim 12, wherein the tuning code is a binary code, in that the values of the separate capacitors are binary weighted, and in that the computing means and the switches are connected, each connection between the computing means and one of the switches carrying a bit of the tuning code, the binary weight of the bit corresponding to the binary weight of the separate capacitor associated with the switch.

14. The electrical apparatus according to claim 11, wherein the computing means of the electrical apparatus are designed to compute the tuning code as a linear interpolation, computing a ratio of the difference between the coded value stored in the first memory and the coded value of the target frequency and of the difference between the coded value stored in the first memory and the coded value stored in the second memory.

15. The electrical apparatus according to claim 12, wherein, the LC resonator comprises a trim capacitor for calibrating the LC resonator to a desired maximum resonance frequency of the LC resonator when all the separate capacitors of the variable capacitance are disconnected.

16. The electrical apparatus according to claim 11, wherein the first memory and the second memory are non-volatile memories.

17. The electrical apparatus according to claim 11, wherein the LC resonator comprises an antenna coil, particularly a miniaturized antenna coil, and in that the electrical apparatus comprises a radio receiver connected to the antenna coil.

18. The electrical apparatus according to claim 12, wherein the switches are transistors, and in that the computing means, the transistors and the separate capacitors of the variable capacitance are integrated on a chip.

19. The electrical apparatus according to claim 18, wherein the separate capacitors of the variable capacitance are integrated on a CMOS chip, and in that the switches are MOS transistors.

20. The electrical apparatus according to claim 11, wherein the LC resonator has a resonance frequency in the VHF or UHF frequency range.

21. An integrated circuit comprising a variable capacitance for tuning an external LC resonator,
wherein the integrated circuit comprises a first memory, for storing therein a coded value of a maximum resonance frequency of the external LC resonator measured in the state of the integrated circuit being connected in parallel to the LC resonator, for the variable capacitance set to its minimum value,
wherein the integrated circuit comprises a second memory, for storing therein a coded value of a minimum resonance frequency of the external LC resonator measured in the state of the integrated circuit being connected in parallel to the LC resonator, for the variable capacitance set to its maximum value,
wherein the integrated circuit comprises computing means for computing a tuning code for setting the variable capacitance to a value that results in a target resonance frequency of the external LC resonator in the state of the integrated circuit being connected in parallel to the LC resonator, the computing means being connected to the first memory and to the second memory, and the tuning code being computed as an interpolation between the coded value stored in the first memory and the coded value stored in the second memory for a coded value of the target frequency, and
wherein the integrated circuit comprises means for adjusting the value of the variable capacitance in accordance with the value of the determined tuning code.

22. The integrated circuit according to claim 21, wherein the variable capacitance of the integrated circuit comprises several separate capacitors and switches associated with each of the separate capacitors for selectively connecting the separate capacitors in parallel to the external LC resonator, and in that the integrated circuit comprises means for connecting selected ones of the separate capacitors in parallel to the external LC resonator by closing the switches associated with the selected separate capacitors in accordance with the value of the determined tuning code.

23. The integrated circuit according to claim 22, wherein the tuning code is a binary code, in that the values of the separate capacitors are binary weighted, and in that the computing means and the switches are connected, each connection between the computing means and one of the switches carrying a bit of the tuning code, the binary weight of the bit corresponding to the binary weight of the separate capacitor associated with the switch.

24. The integrated circuit according to claim 21, wherein the computing means are designed to compute the tuning code as a linear interpolation, computing a ratio of the difference between the coded value stored in the first memory and the coded value of the target frequency and of the difference between the coded value stored in the first memory and the coded value stored in the second memory.

25. The integrated circuit according to claim 21, wherein the first memory and the second memory are non-volatile memories.

26. The integrated circuit according to claim 21, wherein the separate capacitors are integrated on a CMOS chip, and in that the switches are MOS transistors.
